(19) United States
(12) Patent Application Publication
(10) Pub. No.: US 2024/0262938 A1
(43) Pub. Date: Aug. 8, 2024

(54) SEMICONTINUOUS SUSPENSION POLYMERIZATION OF POLYACRYLATES IN A CAPILLARY REACTOR

(71) Applicant: Evonik Operations GmbH, Essen (DE)

(72) Inventors: David BAILEY, Coesfeld (DE); Patrick Löb, Mainz (DE); Sibylle von Bomhard, Mainz (DE); Rabea Scherer, Mainz (DE); Anna Musyanovych, Mainz (DE); Manfred Nagel, Reken (DE)

(73) Assignee: Evonik Operations GmbH, Essen (DE)

(21) Appl. No.: 18/567,296

(22) PCT Filed: Jun. 1, 2022
(86) PCT No.: PCT/EP2022/064844

§ 371 Date: Dec. 5, 2023

(30) Foreign Application Priority Data
Jun. 10, 2021 (EP) 21178671.0

(51) Int. Cl. C08F 2/01; B01J 19/00; C08F 2/00; C08F 2/18; C08F 2/24; C08F 6/22; C08F 220/06

(52) U.S. Cl. CPC C08F 2/01; B01J 19/0093; C08F 2/001; C08F 2/18; C08F 2/24; C08F 6/22; C08F 220/06; B01J 2219/00792; B01J 2219/0086; B01J 2219/00873; B01J 2219/00889

(57) ABSTRACT

A process for producing polyacrylate particles by way of suspension polymerization and subsequent agglomeration can be performed. It was based on the problem of specifying a process for producing polyacrylate particles having defined shape and size, which enables improved heat management and requires a minimum amount of organic substances. Mechanical operating steps for establishing the shape and size of the particles—especially grinding and sieving—are to be avoided in order to produce a minimum amount of undersize. Finally, it is possible to implement the process economically on an industrial scale. An essential aspect of the process is that the steps of polymerization and agglomeration are conducted in separate apparatuses, namely suspension polymerization in a continuously operated capillary reactor and agglomeration in a batchwise reactor. The use of microstructured apparatuses is also possible.

The invention relates to a process for producing polyacrylate particles by way of suspension polymerization and subsequent agglomeration.

The term “suspension polymerization” is not used uniformly in the literature and in technical parlance. Consequently, a careful definition of the term is first required here.

Where suspension polymer is mentioned here, this means a process in which droplets of a monomer or monomer solution are polymerized in a continuous phase, where the continuous phase does not dissolve the monomer or the polymer formed.

The term “suspension polymerization” used here therefore conforms to the definition of suspension polymerization in
Slomkowski, S., Alemán, J., Gilbert, R., et al. (2011). Terminology of polymers and polymerization processes in dispersed systems (IUPAC Recommendations 2011). Pure and Applied Chemistry, 83(12), pp. 2229-2259. doi:10.1351/PAC-REC-10-06-03.

At the end of such a process, the polymers formed are suspended as solids in the liquid continuous phase. At the start of the process, the monomer or monomer solution is in the form of droplets within the continuous phase, which implies that the monomer or monomer solution is liquid. Finely divided droplets in a continuous liquid phase are generally referred to as an emulsion. This is the reason why the processes addressed here are also sometimes referred to as “emulsion polymerization”. However, the term “emulsion polymerization”, as defined by Slomkowski, S., Alemán, J., Gilbert, R, et al., is limited to systems on the colloidal scale. However, the invention addressed here does not necessarily take place in a colloid system. Some specialists also use the term “emulsion polymerization” specifically for aqueous systems. But the invention also works in an organic medium. For all these reasons, the term “emulsion polymerization” is inappropriate for the present invention. Reference is made here exclusively to suspension polymerization as per Slomkowski, S., Alemán, J., Gilbert, R., et al If the monomer is present in an aqueous phase finely distributed in an organic dispersant, the process can also be referred to as “inverse suspension polymerization”.

In order not to unnecessarily cause confusion, the term “emulsion” is avoided entirely hereafter. Instead, the term “dispersion” is used when the reaction system according to the invention is to be described.

Dispersions describe mixtures in which liquid droplets and/or solid particles are finely distributed in a continuous liquid phase; cf.
Heusch, R. and Reizlen, K (2000). Disperse Systems and Dispersants in Ullmann's Encyclopedia of Industrial Chemistry, (Ed.) doi:10.1002/14356007.a08_577.

The term “dispersion” therefore refers to the reaction mixture before, during and after polymerization.

Since the monomer droplets are essentially spherical on account of the surface tension before the polymerization, the polymer particles are also essentially spherical immediately after the polymerization. The diameter of the polymer particles corresponds here essentially to the diameter of the droplets. The size of the polymer particles can thus be controlled via the size of the droplets of the monomer.

However, it should be noted that, immediately after commencement of the polymerization, the formed and freshly forming polymer particles begin to coalesce within the dispersion to form larger agglomerates. This process is called agglomeration. In macroscopic terms, the agglomerates in turn are particles that are not necessarily spherical, however. Instead, the agglomerates frequently have the shape of a blackberry, i.e. a regularly shaped, comparatively round but non-spherical body composed of several smaller spheres. Agglomerates may alternatively be irregularly shaped.

Since the agglomerates grow further with time, the control of agglomeration has a great influence on the size of the polymer particles ultimately obtained.

In order to distinguish here between the comparatively spherical small particles and the usually blackberry-shaped larger agglomerates, reference is made in the context of this invention to “primary particles” and “secondary particles”. Primary particles are the polymers formed directly from the polymerization of the monomer droplets, while the term “secondary particles” refers to the agglomerates formed through coalescence of the primary particles.

In industrial processes, polymerization and agglomeration proceed not as strictly separate, successive steps, but also simultaneously. The dispersion at the end of the process therefore still contains non-agglomerated fresh primary particles and secondary particles assembled from former primary particles. The size distribution and morphology of the polymer particles obtained by the process therefore depends on the process regime both in the polymerization and in the agglomeration.

The technological benefit of a suspension polymerization with subsequent agglomeration over other polymerization processes is that the morphology and particle size distribution of the resultant polymer particles can be adjusted quite accurately, and with the aid of chemical engineering means. Mechanical reprocessing of the polymers by means of particle technology can be dispensed with in some applications. Ideally, the particles can already be removed from the suspension in usable shape and size.

Consequently, the production of polymer particles by way of suspension polymerization with subsequent agglomeration is of particular interest when the polymer particles are to have a fixed morphology and size distribution.

An example of industrial relevance in which the morphology and size distribution of polymer particles is important is the production of superabsorbents.

“Superabsorbents” is a term in common use in the field of hygiene articles which is used to refer to water-absorbing polymer particles. In industrial practice, superabsorbents are usually based on polyacrylate or sodium acrylate. They have the ability to absorb large amounts of water or water-based liquids and bind them in a hydrogel. Superabsorbents are incorporated into personal disposable hygiene articles such as nappies, feminine hygiene and incontinence products, where they absorb excreted body fluids and hence fix them in the article. Since hydrogels can barely be expressed, unlike a sponge, the body fluid absorbed remains within the hygiene article even under mechanical pressure.

An introduction into the world of water-absorbing polymer particles is given by.
Markus Frank: Superabsorbents. Ullmann's Encyclopedia of Industrial Chemistry. Published Online: 15 Jan. 2003 DOI: 10.1002/14356007.f25_f01.

In industrial practice, superabsorbents are usually produced as follows:

A monomer solution is provided. This contains at least a monomer, a crosslinker, almost always water, and further auxiliaries. Monomers used are usually ethylenically unsaturated substances, generally acrylic acid. The acrylic acid may also be partly neutralized, for instance with sodium hydroxide solution. Correspondingly, the polyacrylate neutralized with sodium hydroxide solution is more specifically a sodium acrylate. It is also possible for comonomers to be present.

Then the polymerization of the monomer solution is initiated. In the course of the reaction, the monomers form polymer chains that are crosslinked by the crosslinker to give a polymer network. The water present in the monomer solution is incorporated into the polymer network, giving rise to a hydrogel.

The hydrogel is coarsely comminuted and dried, such that the water is driven out of the network. The result is dry, solid polymer material.

This is then brought to the desired grain size by grinding and sieving. The grain size depends on the end use. Usually pulverulent superabsorbents having a grain size of about 300 μm to 800 μm are incorporated into hygiene articles.

Finally, the particles are subjected to postcrosslinking at their surface. They form a core-shell structure, which greatly influences the absorption characteristics of the particles. Further additives are optionally added in order to establish the desired performance in a controlled manner.

As already mentioned, the shape and size of the particles is very important for the usability of the superabsorbents: For instance, irregularly shaped particles have a greater specific surface area than spherical particles. Since a high surface area promotes water absorption, irregularly shaped superabsorbents tend to have faster water absorption than spherical superabsorbents. Small superabsorbent particles, coupled with high specific surface area, simultaneously have low absorption capacity Therefore, these also form a hydrogel more quickly than larger water-absorbing polymer particles. A particularly disadvantageous phenomenon arises when a superabsorbent powder contains both small and large grains: In a nappy, for instance, this has the effect that, after surge-like loading of the superabsorbent bed, the small grains swell first and hence impair the permeability of the overall bed. This has the result that the larger grains of the bed are no longer reached at all by the body fluid, and the hygiene article as a whole fails. This feared phenomenon is called the gel blocking effect. A measure for avoidance of gel blocking is to aim for a very narrow particle size distribution. This suggests that the individual grains of powder are statistically of very substantially equal size and hence have a very substantially equal swell rate.

In order to adjust shape and size of the superabsorbents in the best possible way, in conventional production processes, it is the operating steps of “grinding” and “sieving” that are generally optimized—just because these operating steps crucially determine the shape and size of the superabsorbents. One disadvantage of grinding and sieving is that undersize is always obtained, i.e. water-absorbing particles that are smaller than desired. These fines must be reused in a complex manner in the process. Especially when the recycled fines must not impair the product quality, this requires a high degree of chemical engineering complexity. In order to be able to produce the superabsorbents economically on an industrial scale, the occurrence of fines should therefore be avoided if at all possible.

A technologically completely different approach for avoidance of fines is to polymerize superabsorbent directly in ready-to-use shape and size, such that the mechanical operating steps of “grinding” and “sieving” can be dispensed with.

This enables suspension polymerization with subsequent agglomeration.

WO 2016/087262 A1 (example 6 on page 19) discloses preparing water-absorbing polymer particles based on polyacrylate by suspension polymerization. The reaction is conducted in a stirred tank reactor. It is to be expected that the particles will also agglomerate in the stirred tank reactor. EP2993191A1 (example 1 on page 14) discloses a process for producing water-absorbing polyacrylate particles by way of suspension polymerization and subsequent agglomeration. The polymerization and agglomeration take place in an organic dispersant and in the presence of a surfactant. The two process steps are conducted in a stirred tank reactor. Secondary polyacrylate particles already have the desired particle size distribution, such that no additional grinding or classifying steps for establishment of the final particle size distribution are required after the agglomeration.

One disadvantage of this prior art is that the suspension polymerization must be conducted in a comparatively large stirred tank reactor in order to be able to produce superabsorbents on an industrial scale. Heat management is difficult in the case of large stirred tank reactors; it is difficult to remove heat of reaction from the interior of the reactor in particular. Since the polymerization of acrylic acid to give polyacrylate is highly exothermic, there is a significant rise in the temperature in the interior of the stirred tank reactor. For instance, there can be locally limited overheating of the freshly formed polymer particles, which in turn has an adverse effect on the product quality. In a stirred tank, this can ultimately only be prevented by a correspondingly large amount of dispersant in which the polymers are not so highly concentrated. Consequently, a correspondingly large reactor volume is also required, which causes capital costs and operating costs to rise. The advantage of the grinding and classification steps that have been dispensed with is thus lost again. In addition, organic substances usable as dispersants are frequently harmful to health and the environment and should consequently not be used in a large amount.

In the light of this prior art, it is an object of the invention to specify a process for producing polymer particles based on acrylic acid and having defined shape and size, which enables improved heat management and requires a minimum amount of organic substances. Mechanical operating steps for establishing the shape and size of the particles—especially grinding and sieving—are to be avoided in order to produce a minimum amount of undersize. Finally, it is to be possible to implement the process economically on an industrial scale.

These objects are achieved by a process according to Claim 1.

The invention therefore provides a process for producing polyacrylate particles by way of suspension polymerization and agglomeration, comprising the following steps:
a) providing a monomer solution having at least the following components:
   acrylic acid that may have been at least partly neutralized;
   at least one crosslinker;
   at least one initiator or a portion of an initiator system.
   water;
b) providing an organic dispersant which is an aliphatic hydrocarbon or a mixture comprising an aliphatic hydrocarbon;
c) providing at least one surfactant;
d) providing at least one Pickering emulsifier;
e) producing a dispersion by dispersing the monomer solution in the dispersant,
f) polymerizing the acrylic acid within the dispersant in the presence of the surfactant, which affords primary polyacrylate particles suspended in the dispersant,
g) agglomerating the primary polyacrylate particles within the dispersant and in the presence of the Pickering emulsifier to obtain secondary polyacrylate particles;
h) separating the secondary polyacrylate particles from the dispersant;
i) wherein the polymerizing is effected at least partly in a continuously operated first reactor having a multitude of capillaries aligned in parallel, wherein the interior of the capillaries forms the reaction space of the reactor and wherein the first reactor has at least one conduit that extends along the capillaries and through which a heat carrier medium flows;
k) and wherein the agglomerating is effected at least partially in a discontinuously operated second reactor having at least one vessel, wherein the interior of the vessel forms the reaction space of the second reactor.

The process according to the invention combines a suspension polymerization with a subsequent agglomeration in order to establish the desired particle size and shape. An essential aspect of the process of the invention here is that the steps of polymerization and agglomeration are conducted in separate apparatuses, namely suspension polymerization in a continuously operated capillary reactor and agglomeration in a batchwise reactor.

The use of microstructured apparatuses is a further significant aspect of the invention. The continuously operated first reactor has a multitude of capillaries aligned in parallel, wherein the interior of the capillaries forms the reaction space of the reactor. Along the capillaries, at least one conduit extends through the reactor, through which a heat carrier medium flows. The conduit may ensheath the entirety of the capillaries in tubular form or else be designed as a multitude of conduits interwoven into the multitude of capillaries. The conduit is then likewise designed as a multitude of capillaries and bundled with the reactor capillaries. In both cases, at least the wall of the capillaries separates the heat carrier medium from the reaction mixture. Therefore, heat is transferred between reaction mixture and heat carrier medium without mass transfer. In this respect, a capillary reactor is similar to a shell-and-tube reactor, except that the ratio of length to diameter of a capillary is much greater than in a tube. Compared to tubular reactors, capillary reactors have a large number of capillaries with a small diameter, while tubular reactors achieve the same reactor volume with fewer tubes each of greater diameter. Since the diameters of the capillaries are in some cases in the millimetre or sub-millimetre range, they are also referred to as mini- or microreactors. In order to be able to produce on an industrial scale with such microstructured apparatuses, the apparatuses are correspondingly parallelized and operated with a short dwell time. Since dwell times in capillary reactors are generally shorter than in tubular reactors, different flow conditions also exist therein.

A further important difference between shell-and-tube reactors and capillary reactors is that the multitude of capillaries arranged in parallel need not necessarily be bundled: Shell-and-tube reactors are typically produced by combining (bundling) a multitude of tubes to give a bundle. By contrast, capillary reactors can be additively manufactured, and so the starting material used is not tubes at all, but rather metal powder. The multitude of capillaries aligned in parallel therefore arises directly from the additively combined starting material and not by bundling of tubes.

An introduction into the technology of chemical microstructure technology is given by:
Ehrfeld, W., Hessel, V., Lowe, H. Microreactors: New Technology for Modern Chemistry. Published Online 29 Apr. 2004. Wiley-VCH Verlag GmbH DOI:10.1002/3527601953.

A major advantage of a capillary reactor over a stirred tank reactor is better heat management. Since the heat of reaction in a capillary reactor is removed essentially via the heat carrier medium and not via the reaction mixture, it is possible to use a heat carrier medium distinctly different from the reaction mixture. It may firstly have a high heat capacity in physical terms, and also belong to a completely different substance class in chemical terms, since it does not take part in the reaction and does not come into contact with reaction participants. For instance, water may be used as heat carrier medium, which is very substantially innocuous and additionally also has a good heat capacity. Since the dispersant has to assume the function of heat removal only to a limited degree in a capillary reactor—namely from the polymerizing droplets or fresh particles on the wall of the capillary—the dispersant can be used in much smaller amounts than in a stirred tank reactor This is advantageous especially when the dispersant, owing to its contact with the reaction participants, must be a particular chemical substance that is a hazardous material.

A further advantage of a microreactor is its high process intensity. This reduces the build space compared to a batchwise reactor, which unlocks advantages in setup costs.

The high process intensity is also achieved in a capillary reactor by virtue of a short dwell time. Since many polymerisations proceed quite rapidly, this can also be conducted in capillary reactors. The situation is different for agglomeration: This requires a certain time, which is not available in a capillary reactor. In order nevertheless to enable agglomeration, the invention envisages performing the agglomeration prior to the polymerization in a separate apparatus, namely in a batchwise reactor.

The batchwise reactor in the simplest case is a vessel, the interior of which forms the reaction space in which the agglomeration proceeds Since agglomeration is not as highly exothermic as polymerization, careful heat management during agglomeration is unimportant. Instead, it is important to correctly control the dwell time in the batchwise reactor, since the time made available to the particles for agglomeration determines the size and shape of the agglomerates. The dwell time in the batchwise reactor can be efficiently controlled since the secondary particles are simply removed from the batchwise reactor once the envisaged dwell time after the primary particles have been supplied to the batchwise reactor has elapsed.

In principle, in the process according to the invention, when the primary particles are transferred from the first reactor to the second reactor, there is a changeover from continuous operation to batchwise operation. The process is therefore a semicontinuous process.

Although the dwell time in the continuously operated capillary reactor is much shorter than in the discontinuously operated batchwise reactor, the primary particles cannot be prevented from agglomerating even in the capillary reactor. There will likewise be subsequent polymerization in the batchwise reactor of droplets that have not polymerized so far. Therefore, in the process according to the invention, the steps of “polymerization” and “agglomeration” do not take place in an ideally separated manner and do not take place exclusively in the first or second reactor. The aim in accordance with the invention is therefore to allow at least partial polymerization to take place in the first reactor and agglomeration at least partly in the second reactor. It is particularly preferable to perform each of the two process steps as completely as possible in the respective reactor in a dedicated manner.

The apparatus separation of polymerization and agglomeration overall enables better control over the size distribution of the particles produced in accordance with the invention. The capillary reactor enables better heat management and hence prevents losses of quality resulting from local overheating of the polymer particles. Finally, the need for dispersants is reduced. These are essentially the advantages achieved by the invention.

The surfactant is required in order to better distribute the monomer droplets in the continuous phase. The Pickering emulsifier is required to generate larger primary particles.

In a preferred development of the invention, the preparing of the dispersion and the polymerizing of the monomer are effected in the presence of the surfactant and of the Pickering emulsifier. This is achieved in that both the surfactant and the Pickering emulsifier are provided in the dispersant. This means that the two auxiliaries are already introduced into the dispersant upstream the first reactor. Since the first reactor is operated continuously, it is possible to meter Pickering emulsifier and surfactant continuously into the dispersant. The mixing can preferably be effected there with a static mixer that does not need any moving parts. The use of a static mixer has the advantage that the properties of the dispersion can thus be better adjusted. More particularly, the static mixer enables a particularly homogeneous distribution of the two auxiliaries in the dispersant.

The mixing of the two auxiliaries in the dispersant is preferably effected in separate batches and consequently in two steps. Accordingly, in a preferred development of the process, surfactant and Pickering emulsifier are provided separately, namely in a first batch comprising the dispersant and the surfactant and in a second batch comprising the dispersant and the Pickering emulsifier, and the dispersion is prepared in two steps, namely with a first step in which the monomer is mixed with the first batch and with a second step in which the mixture of first batch and monomer is mixed with the second batch. This procedure leads to better homogenization of the reaction mixture and therefore permits more sparing use of the auxiliaries.

The batches are preferably mixed with microstructured apparatuses. This has the advantage that the fluid dynamics that exist in microstructured apparatuses can be maintained beyond the apparatus boundaries. Preferably, the microstructured apparatuses are even connected to one another via capillaries, such that there is no significant change in the flow conditions at the transition from one apparatus to the next.

In a particularly preferred embodiment, the second step in which the mixture of first batch and monomer is mixed with the second batch is effected in at least one microstructured mixer. More particularly, a caterpillar mixer can be used for the purpose.

A caterpillar mixer is a static mixer in microstructural design. It comprises a channel through which the fluids to be mixed flow, along which is arranged a multitude of upward and downward ramps arranged in succession. The ramps result in multiple splitting and recombination of the flow through the channel, such that the two batches are mixed intensively. The particular mixer geometry additionally permits a high throughput, such that the capillary reactor can be fed sufficiently with the dispersion.

A more accurate description of a caterpillar reactor can be found in the above-cited monograph by Ehrfeld et al., section 3.7.4 pages 62 ff.

For the first step of the mixing, in which the monomer is mixed with the first batch, preference is likewise given to using a microstructural static mixer. However, what is called an interdigital mixer is of better suitability for this mixing task than a caterpillar mixer, especially at low flow rates.

In an interdigital mixer, the streams to be mixed are split into many small substreams and then alternately contacted again with one another for mixing. A more accurate description of an interdigital reactor can be found in the above-cited monograph by Ehrfeld et al., section 3.8.1 pages 64 ff.

When a caterpillar mixer is used in the first step, this should have a smaller internal structure size than the caterpillar mixer which is preferably used in the second step, in which the mixture of first batch and monomer is mixed with the second batch.

In a preferred development of the invention, therefore, the first step in which the monomer is mixed with the first batch is effected in at least one interdigital mixer or in a caterpillar mixer, the internal structure size of which is less than that of the caterpillar mixer which is used for the second step. This has the result that the droplet size of the dispersion which is produced in the first mixing step is maintained in the second mixing step.

Since the Pickering emulsifier is required only in the agglomeration, it is possible to meter in the Pickering emulsifier only immediately upstream of the agglomeration. This means that the polymerization is effected in the absence of the Pickering emulsifier. By contrast, the presence of the surfactant during the dispersion is indispensable.

In a corresponding process variant, the surfactant is accordingly provided in the dispersant, and the Pickering emulsifier is metered in only on commencement of the agglomeration, in such a way that the preparation of the dispersion and the polymerization are effected in the presence of the surfactant and in the absence of the Pickering emulsifier.

According to the definition of suspension polymerization used here, neither the monomer (the acrylic acid) nor the polymer (polyacrylate) is soluble in the dispersant. Monomer and polymer must consequently be stable with respect to the dispersant. What is meant by stability in the case of the polymer is more particularly that the polymer does not swell in the dispersant. This means that the dispersant does not migrate into the polymer and hence cause a change in volume of the particles. Swelling is still not dissolution of the polymer in the dispersant, but it is nevertheless undesirable that the dispersant remains in the swollen polymer and has to be driven out again in a complex manner if necessary. For that reason, the swelling characteristics of the polymer with respect to the dispersant should be at a minimum.

The swelling characteristics of polymers with respect to liquids are generally very different, and are also temperature-dependent. A standardized test method for determination of the swelling of solid polymers with respect to liquids is described by DIN EN ISO 175. This involves immersing a test specimen into the test fluid at a particular temperature and then determining the change in its volume.

In relation to the present invention, it is appropriate when the percentage change in mass of the polyacrylate particles on immersion into the dispersant, determined according to DIN EN ISO 175, date of issue 2011 Mar. 1, at a test temperature of 70° C. and a test duration of 1 h is less than 100.

This means that the volume of the particles does not double when the particles are immersed in the dispersant at 70° C. for one hour. With regard to the production of the superabsorbents, this means that water is entirely unsuitable as dispersant since superabsorbents can absorb up to one thousand times their dry weight of water, and in so doing swell to a much greater degree than 100%.

The present process is of excellent suitability for production of superabsorbents. For this purpose, a specific monomer solution is provided in accordance with the invention, comprising the following components:
a) acrylic acid as monomer that may have been at least partly neutralized.
b) at least one crosslinker;
c) at least one initiator or a portion of an initiator system.
d) water.

Since water is unsuitable as dispersant on account of the high water absorption of the superabsorbents, the dispersant used is an aliphatic hydrocarbon. Alternatively, the dispersant used may be a mixture containing at least one aliphatic hydrocarbon.

The substance used here as monomer is acrylic acid. Partly neutralized acrylic acid is likewise acrylic acid for the purposes of the invention. If the acrylic acid has been neutralized with alkali metals, for instance with sodium hydroxide, corresponding alkali metal acrylates are obtained as polymer, for instance sodium acrylate. An alkali metal acrylate is likewise a polyacrylate for the purposes of the invention.

As well as acrylic acid, the monomer solution may also contain further monomers that are copolymerized with acrylic acid. If copolymers are polymerized into the polymer particles, reference is still made to polyacrylate particles in this connection by way of simplification.

A copolymer that can be used for production of superabsorbents should preferably be ethylenically unsaturated and have at least one acid group.

Examples of ethylenically unsaturated monomers or comonomers containing acid groups are acrylic acid, methacrylic acid, ethacrylic acid, alpha-chloroacrylic acid, alpha-cyanoacrylic acid, beta-methylacrylic acid (crotonic acid), alpha-phenylacrylic acid, beta-acryloyloxypropionic acid, sorbic acid, alpha-chlorosorbic acid, 2′-methylisocrotonic acid, cinnamic acid, p-chlorocinnamic acid, beta-stearyl acid, itaconic acid, citraconic acid, mesaconic acid, glutaconic acid, aconitic acid, maleic acid, fumaric acid, tricarboxyethylene and maleic anhydride, preference being given particularly to acrylic acid and methacrylic acid and additionally to acrylic acid Acrylic acid is the standard monomer usually used in the industrial production of superabsorbents.

The ethylenically unsaturated monomers bearing acid groups may have been partly or fully neutralized, preferably partly neutralized. The monoethylenically unsaturated monomers containing acid groups have preferably been neutralized to an extent of at least 10 mol %, more preferably to an extent of at least 25 to 50 mol % and further preferably to an extent of 50 to 90 mol %. The neutralization of the monomers may precede or else follow the polymerization. In this case, the partial neutralization is effected to an extent of at least 10 mol %, more preferably to an extent of at least 25 to 50 mol % and further preferably to an extent of 50 to 90 mol %. Moreover, neutralization can be effected with alkali metal hydroxides, alkaline earth metal hydroxides, ammonia, and carbonates and bicarbonates. In addition, any further base which forms a water-soluble salt with the acid is conceivable. Mixed neutralization with different bases is also conceivable. Preference is given to neutralization with ammonia or with alkali metal hydroxides, more preferably with sodium hydroxide or with ammonia.

Suitable crosslinkers are especially what are called condensation crosslinkers that have at least two ethylenically unsaturated groups within a molecule Examples of these are:
alkenyl di(meth)acrylates, for example ethylene glycol di(meth)acrylate, 1,3-propylene glycol di(meth)acrylate, 1,4-butylene glycol di(meth)acrylate, 1,3-butylene glycol di(meth)acrylate, hexane-1,6-diol di(meth)acrylate, decane-1,10-diol di(meth)acrylate, dodecane-1,12-diol di(meth)acrylate, octadecane-1,18-diol di(meth)acrylate, cyclopentanediol di(meth)acrylate, neopentyl glycol di(meth)acrylate, methylene di(meth)acrylate or pentaerythritol di(meth)acrylate, alkenyldi(meth)acrylamides, for example N-methyldi(meth)acrylamide, N,N′-3-methylbutylidenebis(meth)acrylamide, N,N′-(1,2-dihydroxyethylene)bis(meth)acrylamide, N,N′-hexamethylenebis(meth)acrylamide or N,N′-methylenebis(meth)acrylamide, polyalkoxy di(meth)acrylates, for example diethylene glycol di(meth)acrylate, triethylene glycol di(meth)acrylate, tetraethylene glycol di(meth)acrylate, dipropylene glycol di(meth)acrylate, tripropylene glycol di(meth)acrylate or tetrapropylene glycol di(meth)acrylate, bisphenol A di(meth)acrylate, ethoxylated bisphenol A di(meth)acrylate, benzylidene di(meth)acrylate, 1,3-di(meth)acryloyloxy-2-propanol, hydroquinone di(meth)acrylate, di(meth)acrylate esters of trimethylolpropane which has preferably been alkoxylated, preferably ethoxylated, with 1 to 30 mol of alkylene oxide per hydroxyl group, thioethylene glycol di(meth)acrylate, thiopropylene glycol di(meth)acrylate, thiopolyethylene glycol di(meth)acrylate, thiopolypropylene glycol di(meth)acrylate, divinyl ethers, for example butane-1,4-diol divinyl ether, divinyl esters, for example divinyl adipate, alkadienes, for example butadiene or 1,6-hexadiene, divinylbenzene, di(meth)allyl compounds, for example di(meth)allyl phthalate or di(meth)allyl succinate, homo- and copolymers of di(meth)allyldimethylammonium chloride and homo- and copolymers of diethyl(meth)allylaminomethyl (meth)acrylate ammonium chloride, vinyl (meth)acryloyl compounds, for example vinyl (meth)acrylate, (meth)allyl (meth)acryloyl compounds, for example (meth)allyl (meth)acrylate, (meth)allyl (meth)acrylate ethoxylated with 1 to 30 mol of ethylene oxide per hydroxyl group, di(meth)allyl esters of polycarboxylic acids, for example di(meth)allyl maleate, di(meth)allyl fumarate, di(meth)allyl succinate or di(meth)allyl terephthalate, compounds having 3 or more ethylenically unsaturated, free-radically polymerizable groups, for example glyceryl tri(meth)acrylate, (meth)acrylate esters of glycerol which has been ethoxylated with preferably 1 to 30 mol of ethylene oxide per hydroxyl group, trimethylolpropane tri(meth)acrylate, tri(meth)acrylate esters of trimethylolpropane which has preferably been alkoxylated, preferably ethoxylated, with 1 to 30 mol of alkylene oxide per hydroxyl group, trimethacrylamide, (meth)allylidene di(meth)acrylate, 3-allyloxy-1,2-propanediol di(meth)acrylate, tri(meth)allyl cyanurate, tri(meth)allyl isocyanurate, pentaerythritol tetra(meth)acrylate, pentaerythritol tri(meth)acrylate, (meth)acrylic esters of pentaerythritol ethoxylated with preferably 1 to 30 mol of ethylene oxide per hydroxyl group, tris(2-hydroxyethyl) isocyanurate tri(meth)acrylate, trivinyl trimellitate, tri(meth)allylamine, di(meth)allylalkylamines, for example di(meth)allylmethylamine, tri(meth)allyl phosphate, tetra(meth)allylethylenediamine, poly(meth)allyl esters, tetra(meth)allyloxyethane or tetra(meth)allylammonium halides.

Alternatively, it is also possible to use polyols as crosslinkers. Examples of polyols suitable as crosslinkers are:
ethylene glycol, polyethylene glycols such as diethylene glycol, triethylene glycol and tetraethylene glycol, propylene glycol, polypropylene glycols such as dipropylene glycol, tripropylene glycol or tetrapropylene glycol, butane-1,3-diol, butane-1,4-diol, pentane-1,5-diol, pentane-2,4-diol, hexane-1,6-diol, hexane-2,5-diol, glycerol, polyglycerol, trimethylolpropane, polyoxypropylene, oxyethylene-oxypropylene block copolymers, sorbitan fatty acid esters, polyoxyethylene sorbitan fatty acid esters, pentaerythritol, polyvinyl alcohol and sorbitol, amino alcohols, for example ethanolamine, diethanolamine, triethanolamine or propanolamine, polyamine compounds, for example ethylenediamine, diethylenetriamine, triethylenetetramine, tetraethylenepentamine or pentaethylenehexamine, polyglycidyl ether compounds such as ethylene glycol diglycidyl ether, polyethylene glycol diglycidyl ether, glyceryl diglycidyl ether, glyceryl polyglycidyl ether, pentaerythrityl polyglycidyl ether, propylene glycol diglycidyl ether, polypropylene glycol diglycidyl ether, neopentyl glycol diglycidyl ether, hexanediol glycidyl ether, trimethylolpropane polyglycidyl ether, sorbitol polyglycidyl ether, diglycidyl phthalate, diglycidyl adipate, 1,4-phenylenebis(2-oxazoline), glycidol, polyisocyanates, preferably diisocyanates such as toluene 2,4-diisocyanate and hexamethylene diisocyanate, polyaziridine compounds such as 2,2-bishydroxymethylbutanol tris[3-(1-aziridinyl)propionate], hexamethylene-1,6-diethyleneurea and diphenylmethanebis-4,4′-N,N′-diethyleneurea, halogen peroxides, for example epichloro- and epibromohydrin and a-methylepichlorohydrin, alkylene carbonates such as 1,3-dioxolan-2-one (ethylene carbonate), 4-methyl-1,3-dioxolan-2-one (propylene carbonate), 4,5-dimethyl-1,3-dioxolan-2-one, 4,4-dimethyl-1,3-dioxolan-2-one, 4-ethyl-1,3-dioxolan-2-one, 4-hydroxymethyl-1,3-dioxolan-2-one, 1,3-dioxan-2-one, 4-methyl-1,3-dioxan-2-one, 4,6-dimethyl-1,3-dioxan-2-one, 1,3-dioxolan-2-one, poly-1,3-dioxolan-2-one, polyquaternary amines such as condensation products of dimethylamines and epichlorohydrin. Preferred compounds of crosslinker class II are additionally polyoxazolines such as 1,2-ethylenebisoxazoline, crosslinkers with silane groups, such as y-glycidoxypropyltrimethoxysilane and y-aminopropyltrimethoxysilane, oxazolidinones such as 2-oxazolidinone, bis- and poly-2-oxazolidinones and diglycol silicates.

Finally, it is also possible to use hydroxyl- or amino-containing esters of (meth)acrylic acid as crosslinkers. Examples of these are 2-hydroxyethyl (meth)acrylate and 2-hydroxypropyl (meth)acrylate, and also hydroxyl- or amino-containing (meth)acrylamides or mono(meth)allyl compounds of diols.

The monomer solution for production of the superabsorbents may of course also contain multiple crosslinkers of the structures mentioned.

If acrylic acid is used as monomer, the following crosslinkers are most preferred:

N,N′-methylenebisacrylamide, polyethylene glycol di(meth)acrylates, triallylmethylammonium chloride, tetraallylammonium chloride, and allyl nonaethylene glycol acrylate prepared with 9 mol of ethylene oxide per mole of acrylic acid.

In order to bring about the polymerization, an initiator or at least a portion of an initiator system is required, which is provided in the monomer solution.

The polymerization can in principle be initiated using any of the initiators that form free radicals under the polymerization conditions and are typically used in the production of superabsorbents. These include thermal initiators and redox initiators. The initiators are dissolved or dispersed in the monomer solution. If the monomer solution is aqueous, water-soluble initiators should be used.

In the process according to the invention, particular preference is given to using thermal initiators that break down thermally to free radicals. The reason for this is the use of the capillary reactor By contrast with the use of a redox-based initiator system, only one component is required as initiator, and so the intensity of mixing falls. Since the capillary reactor enables good heat management, thermal initiator can be efficiently dissolved in the capillary.

On account of the short dwell times in the capillary reactor, thermal polymerization initiators having a short half-life are of particular interest for the present process. The half-lives should be below 10 seconds, further preferably less than 5 seconds, in each case at a temperature of less than 180° C., further preferably at less than 140° C. Peroxides, hydroperoxides, hydrogen peroxide, persulfates and azo compounds are particularly preferred thermal polymerization initiators. Particular preference is given to using potassium peroxodisulfate as the sole initiator. In some cases, by contrast, it is advantageous to use mixtures of different thermal polymerization initiators. Among these mixtures, preference is given to those of hydrogen peroxide and sodium peroxodisulfate or potassium peroxodisulfate, which can be used in any conceivable ratio.

Suitable organic peroxides are preferably acetylacetone peroxide, methyl ethyl ketone peroxide, benzoyl peroxide, lauroyl peroxide, acetyl peroxide, capryl peroxide, isopropyl peroxydicarbonate, 2-ethylhexyl peroxydicarbonate, t-butyl hydroperoxide, cumene hydroperoxide, t-amyl perpivalate, t-butyl perpivalate, t-butyl perneohexonate, t-butyl isobutyrate, t-butyl per-2-ethylhexenoate, t-butyl perisononanoate, t-butyl permaleate, t-butyl perbenzoate, t-butyl 3,5,5-trimethylhexanoate and amyl perneodecanoate. Further preferred thermal polymerization initiators are: azo compounds such as azobisisobutyronitrile, azobisdimethylvaleronitrile, 2,2′-azobis(2-amidinopropane) dihydrochloride, azobisamidinopropane dihydrochloride, 2,2′-azobis(N,N-dimethylene)isobutyramidine dihydrochloride, 2-(carbamoylazo)isobutyronitrile and 4,4′-azobis(4-cyanovaleric acid). The compounds mentioned are used in customary amounts, preferably within a range from 0.01 to 5 mol %, preferably from 0.1 to 2 mol %, based in each case on the amount of the monomers to be polymerized.

As an alternative to a thermal initiator, it is also possible to use a redox system consisting of at least two components as initiator One component here has reducing action, the other oxidizing action. In order to initiate the redox-induced polymerization, the reducing component and the oxidizing component of the redox system are mixed. This can be effected immediately upstream of or better only within the capillary reactor, since the polymerization otherwise commences too early and the polymers block the capillaries. Consequently, the monomer solution is provided only with one component of the initiator system and then mixed with the second component. This is somewhat more complicated, and therefore preference is given to thermal initiators.

If a tried-and-tested redox system is nevertheless to be used, suitable oxidic components are at least one of the above-specified per compounds, and suitable reducing components are preferably ascorbic acid, glucose, sorbose, mannose, ammonium hydrogensulfite, sulfate, thiosulfate, hyposulfite or sulfide, alkali metal hydrogensulfite, sulfate, thiosulfate, hyposulfite or sulfide, metal salts such as iron(II) ions or silver ions, or sodium hydroxymethylsulfoxylate. The reducing component used in the redox initiator is preferably ascorbic acid or sodium pyrosulfite. Based on the amount of monomers used in the polymerization, 1*10⁻⁵ to 1 mol % of the reducing component of the redox initiator and 1*10⁻⁵ to 5 mol % of the oxidizing component of the redox initiator are used. Instead of the oxidizing component of the redox initiator, or in addition thereto, it is possible to use one or more, preferably water-soluble, azo compounds.

A particular tried-and-tested redox system is composed of hydrogen peroxide, sodium peroxodisulfate and ascorbic acid. In general, the polymerization is initiated with these initiators within a temperature range from 0° C. to 90° C.

On account of the short dwell times in the capillary reactor, photoinitiators, the breakdown of which is triggered by the action of high-energy radiation, are less suitable for the present process. The aliphatic hydrocarbon which is used as dispersant is preferably cyclohexane. Alternatively, it is possible to use the following aliphatic hydrocarbons as dispersants: n-hexane, n-heptane, 2-methylhexane, 2-methylhexane, 2,3-dimethylpentane, 3-ethylpentane, n-octane, methylcyclohexane, cyclopentane, methylcyclopentane, trans-1,2-dimethylcyclopentane, cis-1,3-dimethylcyclopentane, trans-1,3-dimethylcyclopentane. It is of course also possible to use mixtures of these aliphatic hydrocarbons as dispersant.

The surfactant is preferably a sorbitan fatty acid ester Examples of suitable sorbitan fatty acid esters are sorbitan monostearate (E491), sorbitan tristearate (E492), sorbitan monolaurate (E493), sorbitan monooleate (E494), sorbitan monopalmitate (E495), and sorbitan trioleate. The sorbitan fatty acid esters with the E numbers listed have food approval and are therefore preferred for contact with hygiene articles. Particular preference is given to sorbitan monolaurate (E493) and sorbitan monooleate (E494). It is also possible to use mixtures of these surfactants.

The Pickering emulsifier used is preferably an organoclay. Organoclays are organically aftertreated sheet silicates. Preference is given to using a sheet silicate aftertreated with quaternary ammonium salts, more preferably a bentonite aftertreated with quaternary ammonium salts (Quaternary Ammonium Bentonite Complex, QABC). A suitable organoclay of the QABC type is obtainable from Byk-Chemie GmbH, Wesel (Germany) under the Tixogel-VZ trade name.

It has already been mentioned that capillaries have a much smaller cross section compared to tubes of the same length. More preferably, the L/d ratio of each capillary is between 50 and 500. L here denotes the length of the capillary, and d the equivalent diameter. The equivalent diameter refers to the diameter of a theoretical circle, the cross-sectional area of which is identical to the cross-sectional area of the capillary. Given a square cross-sectional area with side length a, the equivalent diameter d is accordingly calculated as:

$$d = 2 * a / √ π$$

If the capillary has a circular cross section, the equivalent diameter corresponds to the actual diameter.

The equivalent diameter of a capillary is preferably between 1 mm and 10 mm. All capillaries preferably have the same equivalent diameter.

In order to improve the removal of heat from the first reactor, the heat carrier medium can be guided through a multitude of conduits along the capillaries. In this way, the conduits may be in an alternating arrangement with the capillaries in which the reaction takes place. Accordingly, in a preferred embodiment of the invention, the first reactor has a multitude of conduits that extend along the capillaries and through which the heat carrier medium flows, in such a way that the conduits for the heat carrier medium and the capillaries form a collective parallel arrangement. The conduits through which the heat carrier medium flows along the capillaries may be similar in terms of their dimensions to the capillaries, i.e. cross-sectional area and length may be essentially the same. In order to improve the removal of heat, the capillaries (reaction space) and conduits (heat transfer) may be arranged alternately or in a sandwich-like manner within the parallel arrangement.

A particularly preferred formulation for production of superabsorbents by the process of the invention has the following composition:

### Monomer Solution:

Acrylic acid as monomer;
33% by weight to 50% by weight of sodium hydroxide, based on the weight of acrylic acid;
164% by weight to 247% by weight of water, based on the weight of acrylic acid;
778 ppm by weight to 1167 ppm by weight of N,N′-methylenebisacrylamide as crosslinker, based on the weight of acrylic acid;
1206 ppm by weight to 1809 ppm by weight of potassium peroxodisulfate as initiator, based on the weight of acrylic acid,

### Dispersant:

Cyclohexane, where the amount of cyclohexane used is 606% by weight to 909% by weight, based on the weight of acrylic acid;

### Surfactant:

Sorbitan fatty acid ester, where the amount of sorbitan fatty acid ester used is 1% by weight to 2% by weight, based on the weight of acrylic acid;
   Pickering emulsifier:
Sheet silicate, where the amount of sheet silicate used is 2% by weight to 3% by weight, based on the weight of acrylic acid.

Most preferably, the monomer solution according to this formulation is provided as follows.
a) providing acrylic acid;
b) providing aqueous sodium hydroxide,
c) providing methylenebisacrylamide;
d) providing an aqueous solution comprising potassium peroxodisulfate;
e) mixing acrylic acid, aqueous sodium hydroxide and methylenebisacrylamide to obtain neutralized acrylic acid;
f) mixing the neutralized acrylic acid with the aqueous solution comprising potassium peroxodisulfate in at least one interdigital mixer.

A particular advantage of this superabsorbent production is that the superabsorbents can be removed from the agglomeration already in usable size without any need for further operating steps for adjustment of the particle size distribution. This not only saves additional operating steps but also reduces the occurrence of fines. In a particular development of the process, the secondary polyacrylate particles separated from the dispersant are accordingly dried, wherein the D₅₀ value of the particle size distribution of the dried secondary polyacrylate particles determined according to ISO 17190-3 (2001-12-01 edition) is between 200 μm and 600 μm, with the proviso that neither the separated secondary polyacrylate particles nor the dried secondary polyacrylate particles are subjected to grinding and/or classification.

The separated secondary polyacrylate particles may be dried using commonly known dryer designs. Suitable dryers are, in particular, spray dryers or rotary dryers. Both dryer designs are commercially available from various apparatus manufacturers. They are described in detail in
Tsotsas, E., Metzger, T., Gnielinski, V. and Schlünder, E. (2010). Drying of Solid Materials. In Ullmann's Encyclopedia of Industrial Chemistry, (Ed.).
Section 2.1.5. and Section 2.2.4 doi:10.1002/14356007.b02_04.pub2;

The use of a spray dryer has the advantage that the water can be driven out of the polymer particles in a comparatively gentle manner, such that the drying is not accompanied by any significant changes in the morphology of the polymer particles. Spray dryers are therefore particularly preferred.

The invention is now to be elucidated in detail by working examples. For this purpose, the figures show:

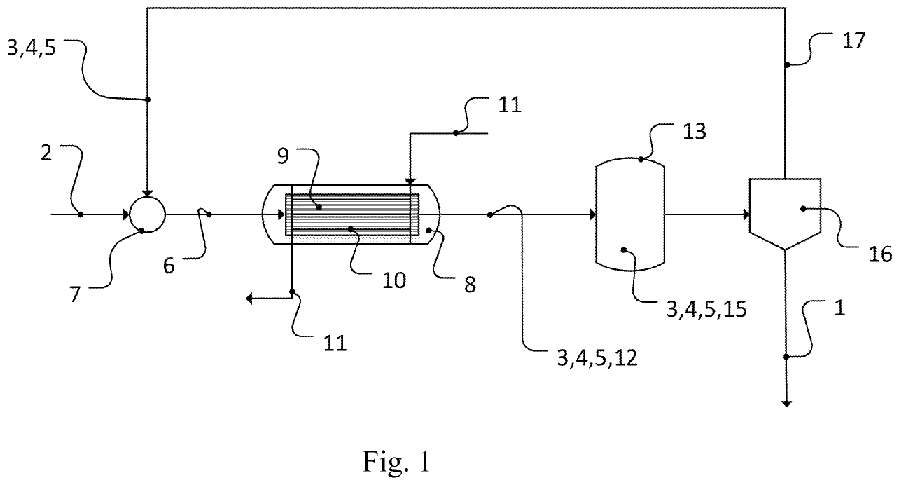

FIG. 1: Process sequence, schematic;

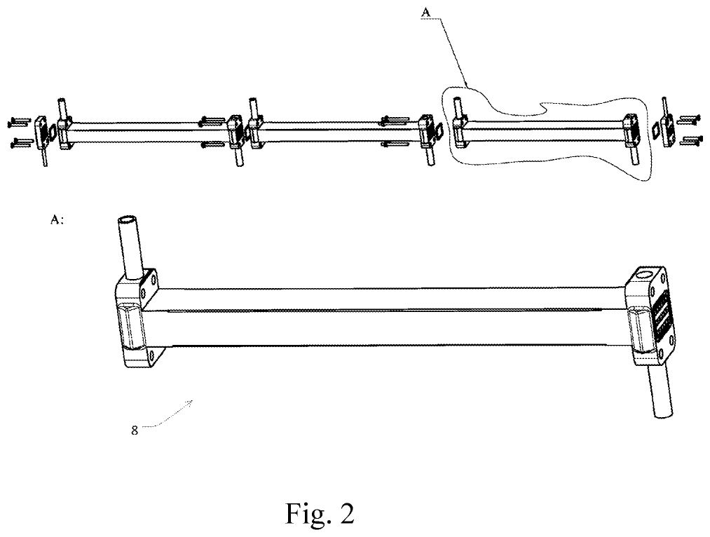

FIG. 2: Reactor concept;

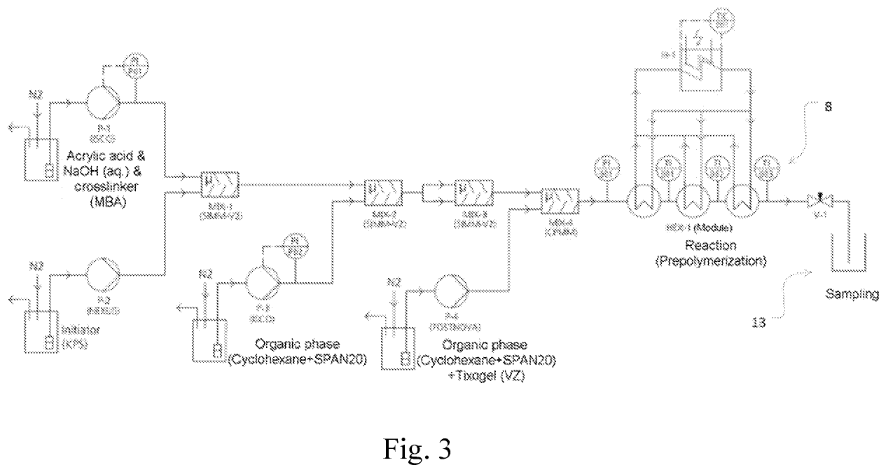

FIG. 3: Process flow diagram of experimental setup;

### PROCESS SEQUENCE

FIG. 1 illustrates the inventive production of polymers by a simplified process flow diagram.

The aim of the process is the production of polyacrylate particles 1. For this purpose, first of all, a monomer 2 is provided in liquid form. The monomer 2 and the way in which it is provided depend on the polymer. In general, the monomer 2 is provided dissolved in a solvent; this is referred to as a monomer solution.

In addition, a liquid dispersant 3 is provided. The dispersant 3 is a medium in which the reaction is conducted and which essentially does not take part in the reaction. The chemical nature of the dispersant 3 depends on the reaction participants.

The process requires two essential auxiliaries, namely a surfactant 4 and a Pickering emulsifier 5. Both substances may be liquid or solid. For them to show their effect during the reaction, they must be finely distributed in the dispersant. Depending on whether surfactant 4 and Pickering emulsifier 5 are liquid or solid, they are dissolved, emulsified or suspended in the dispersant 3. When this is done depends on the process. In the general case, surfactant 4 and Pickering emulsifier 5 are provided in the dispersant 3.

Then a dispersion 6 is produced, in which the monomer 2 is dispersed in the dispersant 3. This is done in a first mixer 7. The dispersion 6 therefore contains the monomer 2, the dispersant 3, the surfactant 4 and the Pickering emulsifier 5.

The dispersion 6 is then transferred into a first reactor 8 in order to polymerize the monomer therein. The first reactor 8 is a continuously operated capillary reactor. This comprises a multitude of capillaries 9. The capillaries 9 form the reaction space of the first reactor 8 in which the polymerization proceeds. The capillaries 9 are in a parallelized arrangement within the first reactor 8. Also incorporated in parallel are a multitude of conduits 10 through which a heat carrier medium 11 is guided. The conduits for the heat carrier medium and the capillaries 9 run in parallel within the arrangement. The dispersion is guided exclusively through the capillaries 9, and the heat carrier medium 11 within the conduits 10. Therefore, heat carrier medium 11 and dispersion 6 are physically separated from one another, and so the heat carrier medium 11 cannot take part in the reaction. Nevertheless, heat exchange between the heat carrier medium 11 and the dispersion 6 can take place via the walls of conduits 10 and capillaries 8. Therefore, the first reactor 8 including its capillaries 9 and conduits 10 is preferably rendered in a highly thermally conductive material, such as metal. In order to increase the packing density, the capillaries 9 and the conduit 10 may be provided with a rectangular cross section. The first reactor 8 is produced with the aid of additive manufacturing methods. This especially enables an increase in the packing density of the capillaries 9 compared to bundled tubes.

An important aspect of the first reactor is its microstructured nature. The capillaries in particular have a very small cross section, and so the equivalent diameter of a capillary 8 is only between 1 mm and 10 mm. In the case of a square cross-sectional area, this corresponds to a side length between 0.89 mm and 8.86 mm. The length of the capillary 8 is very long compared to the equivalent diameter, about 50 to 500 times as long. For instance, a capillary having the equivalent diameter d=0.89 mm may have a length l of 20 cm, such that the l/d ratio is 225.

In this case, the internal volume of a single capillary is only 158 mm³. In order to provide a sufficiently large reaction volume, therefore, a multitude of capillaries are combined in the first reactor. For example, the first reactor may have 10 capillaries, such that the total reaction volume is 15.8 cm³. In order to be able to produce sufficient polymer therewith on an industrial scale, the capillary reactor is run with a very high throughput with the aim of shortening the dwell time in the capillaries. The process intensity is correspondingly high. Alternatively, it is possible to connect a multitude of capillary reactors in parallel in order to increase the overall capacity (numbering up). The dimensions of the individual capillaries are then maintained. In this way, the optimized flow conditions in the capillaries can also be utilized on a larger production scale.

In order to achieve this, efficient heat management is required. This is achieved in that a multitude of conduits 10 for the heat carrier medium 11 is interwoven into the arrangement of the capillaries 8. Preference is given to an alternating arrangement of capillaries 8 and conduits 10, in order that the heat of polymerization that arises in the capillaries 8 can be removed rapidly via the heat carrier medium 11. The conduits 10 and capillaries 8 may also be in a sandwich-like arrangement. The dimensions of the conduits depend on the heat transfer performance required. The aim is to design the conduits 10 in the same order of magnitude (equivalent diameter 1 to 10 mm) as the capillaries 8. The exact cross section of the conduits depends on the heat capacity of the heat carrier medium 11, the temperature thereof and the flow rate thereof.

When the conduits are about as large as the capillaries, they may also be distributed uniformly within the arrangement, which improves the removal of heat. As a result, the first reactor will completely have a microstructured setup, with regard both to the capillaries and to the conduits. The production of microstructured apparatuses in metal is possible by means of additive manufacturing methods, for instance by selective laser melting. There may advantageously be a coating of the metal capillary on the inside, for instance with tetrafluoroethylene-hexafluoropropylene copolymer (FEP) and/or with ceramic.

When the dispersion leaves the first reactor 8 again, the polymerization has essentially taken place. The dispersion 6 then contains solid primary particles 12 suspended in the dispersant 3. Since neither the surfactant 4 nor the Pickering emulsifier 5 takes part in the reaction, these substances are still present in the dispersant 3 even after the polymerization.

The primary particles 12 are a precursor of the later polymer. The primary particles 12 form as a result of polymerization of the monomer droplets within the dispersion 3, and therefore have essentially the size and shape of the monomer droplets. Since the size of the primary particles 12 does not yet correspond to the desired final value, the primary particles 12 are then subjected to an agglomeration in a second process step. The agglomeration is effected in a second reactor 13 specifically intended for the purpose.

The second reactor 13 is arranged downstream of the first reactor 8. It is preferably arranged immediately downstream of the first reactor 8. If further chemical process steps should be required before the agglomeration, it is also conceivable to arrange an intermediate reactor (not shown) between the first reactor 8 and the second reactor 13.

The second reactor 13 is a discontinuously operated (batchwise) reactor. The second reactor 13 has a vessel 14 that forms the reaction space of the second reactor 13. The vessel 14 is filled with the dispersion 6 drawn off from the first reactor 8. When the vessel 14 is full, an exchange reactor not shown in the drawing is filled. In this way, the process switches from a continuous mode of operation (polymerization in the first reactor) to a discontinuous mode of operation (agglomeration in the second reactor).

In the vessel 14 of the second reactor 13, the primary particles 12 are given time to agglomerate to larger secondary particles 15. The dwell time within the vessel 14 is chosen such that the secondary particles 15 take on the ultimately desired size of the finished polyacrylate particles 1. As the case may be, monomer unconverted in the first reactor may subsequently polymerize in the second reactor.

What is important is that the primary particles 12 are distributed homogeneously in the dispersant during the agglomeration, in order that the particle size distribution of the secondary particles 15 is also very substantially homogeneous. For this purpose, the dispersion 6 in the vessel 14 must be stirred up during the agglomeration. The agglomeration can be conducted at elevated temperature. For this purpose, the second reactor 13 may be equipped with a heater.

If necessary, after conclusion of the agglomeration, further chemical process steps on the secondary particles 15 may be conducted within the second reactor 13. For instance, the polyacrylate particles within the second reactor 13 may be subjected to a surface postcrosslinking, such that the secondary particles 15 take on a core/shell structure that has a positive effect on the absorption characteristics of the later superabsorbents. The secondary particles 15 may also be provided with any additives within the dispersion 3 in the second reactor 13. If these process steps require heat, the vessel 14 may be correspondingly heatable or coolable.

On conclusion of the agglomeration and any further steps conducted in vessel 14, the dispersion 6 is withdrawn from the second reactor 13 and transferred into a separation apparatus 16 that separates the finished polyacrylate particles 1 from the dispersion 6.

The separation apparatus 16 may work mechanically (sieve, sponging), thermally (evaporation of the dispersant) or by means of membrane technology. The separation method of choice depends on the system. In the case of superabsorbents, the dispersant may be evaporated since the secondary particles 15 have to be dried in any case in order to drive out the water present in the gel. Removal of water and dispersant can be effected simultaneously in a suitable dryer, for example in a spray dryer.

Depending on the nature of Pickering emulsifiers 5 and surfactant 4, these auxiliaries may be removed simultaneously with the dispersant. Alternatively, the auxiliaries are separated off in a second separation step (not shown).

Preferably, Pickering emulsifier 5 and surfactant 4 are separated off together with the dispersant 3 and recycled along a recycle conduit 17. The recycling can ideally replace the provision of dispersant, Pickering emulsifier and surfactant. In practice, however, a portion of these substances will always be lost, and so corresponding replenishment is necessary (not shown).

### Formulations:

For the working example, the following formulations were provided:

Formulation A Aqueous, Partly Neutralized Acrylic Acid Solution with Crosslinker (as Monomer Solution):

| | | |
|---|---|---|
| Acrylic acid (AA): | 294.5 | g |
| Sodium hydroxide (NaOH): | 122.4 | g |
| Water (H₂O): | 560 | g |
| N,N′-Methylenebisacrylamide (MBA): | 293.6 | mg |

The neutralization level of the acrylic acid is around 75%. The concentration of the MBA crosslinker is 1000 ppm based on the mass of acrylic acid. The density of the solution is around 1.14 g/l. The solution according to formulation A is thus around 4 8 molar in terms of acrylic acid (around 30 wt %).

The flow rate of the solution according to formulation A is 3 ml/min or 3.42 g/min. This results in the following theoretical batch formulation for run time 10 minutes (total of 34.2 g of formulation A solution):

| | | |
|---|---|---|
| Acrylic acid (AA): | 10.26 | g |
| Sodium hydroxide (NaOH): | 4.29 | g |
| Water (H₂O): | 19.62 | g |
| N,N′-Methylenebisacrylamide (MBA): | 0.01 | g |

### Formulation B Aqueous Initiator Solution:

| | | |
|---|---|---|
| Potassium peroxodisulfate (KPS): | 440.35 | mg |
| Water (H₂O): | 42.67 | g |

The solution according to formulation B is thus about 38.2 millimolar in terms of initiator (KPS).

The flow rate of the solution according to formulation B is 0.15 m/min. This results in the following theoretical batch formulation for run time 10 minutes (total of 1.5 ml of formulation B solution):

| | | |
|---|---|---|
| Potassium peroxodisulfate (KPS): | 15.5 | mg |
| Water (H₂O): | 1.5 | g |

### Formulation C Continuous Phase:

| | | |
|---|---|---|
| Cyclohexane (CH): | 1 | l |
| Sorbitan monolaurate (Span 20): | 1.74 | g |

The flow rate of the solution according to formulation C is 5 ml/min. This results in the following theoretical batch formulation for run time 10 minutes (total of 50 ml of formulation C solution):

| | | |
|---|---|---|
| Cyclohexane (CH): | 50 | ml |
| Sorbitan monolaurate (Span 20): | 87 | mg |

### Formulation D Batch Phase:

| | | |
|---|---|---|
| Cyclohexane (CH): | 1 | l |
| Sorbitan monolaurate (Span 20): | 1.74 | g |
| Organoclay (Tixogel VZ): | 5.5 | g |

90 ml initial charge in the batchwise reactor for sampling at 18 minutes. This results in the following batch formulation for run time 10 minutes (total of 50 ml of formulation D solution):

| | | |
|---|---|---|
| Cyclohexane (CH): | 50 | ml |
| Sorbitan monolaurate (Span 20): | 87 | mg |
| Organoclay (Tixogel VZ): | 275 | mg |

### Overall Formulation (Simplified):

Taking account of the respective flow rates (A:B:C=3:0.15:5) [ml/min], the following simplified overall formulation is found:

| Acrylic acid (AA): | 10.28 | g |
|---|---|---|
| Sodium hydroxide (NaOH): | 4.29 | g |
| Water (H₂O): | 21.12 | g |
| N,N′-Methylenebisacrylamide (MBA): | 0.01 | g |
| Potassium peroxodisulfate (KPS): | 15.5 | mg |
| Cyclohexane (CH): | 77.9 g (100 ml) | |
| Sorbitan monolaurate (Span 20): | 174 | mg |
| Organoclay (Tixogel VZ): | 275 | mg |

The molar amount of initiator based on the molar amount of acrylic acid was therefore around 400 ppm. The proportion by weight of crosslinker based on the total mass of acrylic acid was therefore around 1000 ppm.

### Capillary Reactor:

FIG. 2 shows the implementation of the reactor concept in a detailed technical construction. The capillary reactor consists of three individual modules. The modules each include three layers of six reaction channels each with a channel cross section of 2 mm×2 mm and a length of 20 cm. The total reaction volume per module is around 14.4 cm³. The three layers of capillaries are surrounded by four layers of conduits for the heat carrier medium (7×1 mm×2 mm). It was constructed in stainless steel as material using an additive manufacturing method (selective laser melting—SLM).

Polyacrylic acid particles are produced in the capillary reactor. These can potentially stick to the capillary wall and hence block the capillaries in the long term. One way of counteracting this sticking is coating of the capillary with a material on which the adhesion of the polyacrylic acid particles is reduced. In order to provide a remedy, single-channel test pieces were created by means of SLM and then coated. Coating was effected firstly with FEP (tetrafluoroethylene-hexafluoropropylene copolymer) and secondly with ceramic. After the coating, the test pieces were cut open and the quality of the coating was verified by microscope. Both coatings were visually impeccable.

### Experimental Setup:

FIG. 3 shows a process flow diagram of the experimental setup used.

The aqueous partly neutralized acrylic acid admixed with the MBA crosslinker (formulation A) is first mixed with the initiator solution (formulation B) in a micromixer of the SIMM-V2 interdigital mixer type at room temperature. This reaction solution is then dispersed in the organic phase (cyclohexane/Span20—formulation C) via the sequence of two interdigital mixers (SIMM-V2). This was followed by the mixing-in of Tixogel VZ suspended in cyclohexane/Span20 (formulation D) by means of a somewhat coarsely structured micromixer (caterpillar mixer with channel cross section 600 μm×600 μm, CPMM-R600/12). The caterpillar mixer used has a distinctly greater structure size than the interdigital mixer used for dispersion Thus, the caterpillar mixer should not lead to any change in the droplet size of the dispersion.

The reactor used was either a single ⅛″ capillary of FEP with length 20 m or a capillary reactor 8 having a bundle of individual capillaries. The construction variant with the single capillary is not shown in FIG. 3. The capillary reactor 8 was designed as described in the paragraph above. The second reactor 13 (batch) was designed as a three-neck flask with a volume of 250 ml. The temperature of the second reactor was controlled with the aid of an oil bath, and it was stirred by means of a KPG® stirrer.

A rotary dryer and a spray dryer were available for separation of the polyacrylate particles from the dispersion medium and for driving of the water out of the polyacrylate particles.

### Experimental Procedure:

Three processing modes were possible with the laboratory system:
Semicontinuous prepolymerization without capillary: Only the mixing of the partly neutralized acrylic acid solution with the initiator and the dispersing of this mixture were continuous. Thereafter, the dispersion is collected directly in the heated flask in which there is an amount of cyclohexane/Span20/Tixogel VZ corresponding to the sampling duration.
Semicontinuous prepolymerization with capillary: Corresponding to the above variant, except that the dispersion produced is guided through a heated capillary before the sampling in the flask commences.
Continuous prepolymerization: By contrast with the above variant, after the dispersion, the cyclohexane/Span20/Tixogel solution is mixed in continuously before the further processing in the heated capillary.

The flow rate ratios for the continuous case were: partly neutralized AA/MBA: initiator: cyclohexane/Span20:cyclohexane/Span20/Tixogel [ml/min] 3.0:0.3:5.0:5.0 (corresponding to about 1200 ppm of initiator and 1000 ppm of crosslinker).

In the semicontinuous variants, the continuous delivery of cyclohexane/Span20/Tixogel is omitted. The corresponding amount is initially charged in the batch flask.

In the course of preliminary experiments, a single capillary was first used rather than a capillary bundle. The capillary length was 20 m, the diameter ⅛″. This resulted in a reaction volume of Vi=39.2 ml. This results in the following dwell times in the continuous part of the process: semicontinuous prepolymerization without capillary: 0 minutes/semicontinuous prepolymerization with capillary: 4 7 minutes/continuous prepolymerization: 2.9 minutes. Operation of the capillary at 70° C.

Sampling in a 250 ml three-neck flask at oil bath temperature 85° C. over 18 minutes. While stirring by means of KPG stirrer.

Further stirring at 85° C. for around %: h. Then changeover from KPG® stirring to magnetic stirrer/stirrer bar and continued stirring at room temperature for around 3-4 h. Then removal of the particle mass by filtration. Drying under air overnight. Further drying on a rotary evaporator for ultimately around ½ to 1 hour at 50° C. Particularly with these parameters, variation possible from experiment to experiment or sample to sample.

Assessment of the sample quality by microscope images of the rotary-dried samples and microscope images of the fully water-swollen particles.

In experiment PL058, samples were generated for all three processing modes (PL058A, PL0588, PL058C). All cases resulted in particles, or a particle slurry that sediments quickly when the stirring is switched off and can be resuspended. The first particles were observed for about 10 minutes after commencement of sampling. These were agglomerates composed of smaller primary particles. After drying, the particles were capable of swelling in water.

The rotary-dried sample material from experiments PL058A (34 g, of which max. 22 g acrylate), PL058B (33 g, of which max 22 g acrylate) and PL058C (30 g, of which max. 22 g acrylate) was subjected to further sample characterization/analysis.

Then the process was coupled with direct spray drying, with the aim of direct further processing of the polymer particle suspension generated by means of spray drying.

The polymerization was conducted largely under the standardized conditions for the semicontinuous polymerization with capillary (of course without the filtration and drying steps). The composition of the solutions used corresponds to the above-specified formulations.

The flow rates were: partly neutralized AA/MBA (formulation A): initiator (formulation B): cyclohexane/Span20 (formulation C) [ml/min] 3.0:0.15:5.0. The dwell time of the dispersion in the capillary was thus around 4.8 minutes. The initiator concentration was thus around 400 ppm based on the molar amount of acrylic acid, and the crosslinker concentration around 1000 ppm based on the mass of acrylic acid. Material was removed stepwise (typically around 50 ml) from the particle suspension that was being stirred at room temperature at the end and then admixed again with the same amount of cyclohexane/Span20/Tixogel (formulation D) in order to dilute the samples for spray drying. The intention was thus to avoid agglomeration of the particles and improve deliverability by a pump into the spray dryer. About 45-60 minutes was required for spray drying of one batch.

A total of seven batches were conducted. Once the first material was available, the spray drying was effected accompanying the performance of the batches, such that the material was promptly processed further stepwise.

The spray drying in principle gave two fractions: a very fine fraction and a coarse fraction (main mass). The combined coarse fractions from the workup of all seven batches were combined to give a sample (material sample PL075 spray-dried) in order thus to conduct characterizations/analysis.

Apart from the spray drying, the sample is most similar to material sample PL58B in the production process. The consistency of PL075 is largely pulverulent with small agglomerates and free-flowing.

Following the spray drying experiments, a further large sample was generated as a comparison in order to determine the effect of the processing method. The processing corresponds to that in the spray drying experiments up to the point of generation of the polymer particle suspension in the batch. Rather than the further dilution of the suspension and spray drying, there followed the “standard workup” of removal by filtration, air drying and after-drying on a rotary evaporator (water bath temperature up to 95° C., membrane pump vacuum, up to 90 minutes, down to 30 mbar). Again, multiple batches were conducted (maintaining the experimental conditions).

After the drying, the material is in large agglomerates/lumps. There is also a small amount of individual particles.

In this way, it was possible to establish quite a reliable method for generation of the polymer particle suspension. Efforts were then directed to making the process completely continuous again for the prepolymerization part, i.e. undertaking the metered addition of the Tixogel continuously. In parallel, systematic variation of the temperature of the capillary was also undertaken (70° C., 80° C., 85° C. and 95° C.). The aim of increasing the temperature here was to increase the conversion in the capillary.

With increasing temperature, a trend toward smaller particles is observed. Also gained in the course of the experiments was the insight that the formulation and age of the Tixogel suspension can play a role in the experimental result—especially with regard to the general quality of the polymer mass generated.

Therefore, the formulation of the Tixogel was also modified and standardized. The Tixogel suspension is prepared as follows:

0.87 g of Span20 is added to 500 ml of cyclohexane and the mixture is stirred for 5 minutes (500 rpm). 2.75 g of Tixogel is subsequently added, and the mixture is stirred for another 5 minutes. This is followed by a treatment for 2 min by means of the IKA Ultraturrax dispersing device (15 000 rpm). Addition of 0.825 g of water is followed by treatment by Ultraturrax again for 1 min. Thereafter, nitrogen is bubbled through the solution while stirring (500 rpm) Delivery and storage are effected under further stirring.

The last experiments with the temperature increases were already effected with a view to later transfer of the process to the specific capillary reactor.

The aim was to achieve maximum conversion in the continuous part of the process, or to be able to operate with a high flow rate through the reactor and nevertheless to have significant conversion. When flow rates are too low, there is the risk of phase separation, sedimentation, or of deposits.

The existing ⅛″ capillary has a length of 20 m and an internal volume of 39.2 ml. The reactor, when all three modules were used, had a channel length of only 60 cm in the case of parallel flow through all 18 channels, or of 1.80 m in the case of flow through only 6 channels in each case and deflection of the fluid streams twice in the reactor.

Since the temperature was ultimately increased up to 95° C., the next experiment went in the direction of shortening the capillaries used (to 10 m, and internal volume only 19.6 ml) In addition, an attempt was made to increase the conversion in the capillary by increasing the amount of initiator. For this purpose, with the same concentration of initiator solution, the flow rate was increased from 0.15 ml/min through 0.3 ml/min up to 0.6 ml/min.

The trend was for the samples generated to become somewhat tackier with shortened residence time and elevated initiator concentration. For 0.15 ml/min and 0.30 ml/min of initiator solution, however, the samples obtained are still relatively good. Only in the case of 0.60 ml/min of initiator solution does the sample become too inhomogeneous.

The inhomogeneity of the sample with 0.60 ml/min is already manifested in the state after filtration and then also in the dried and in the swollen state.

As a further step, and with a view to the transfer of the process to the polymerization reactor, the ⅛″ FEP capillary (ultimately 10 m, internal volume 19.8 ml) was replaced by a set of ⅛″ stainless steel capillaries (di=2.3 mm, Vi,tot=15.2 ml, Itot=about 8 m). The internal volume thus corresponds roughly to that of a reactor module What was essentially to be tested was whether there is excessively rapid blockage of the capillary when the surface material is changed from FEP to stainless steel.

Two experiments were conducted: one at 90° C. with 0.30 ml/min of initiator solution and one at 95° C., likewise with 0.30 ml/min of initiator solution. The processing in the capillary ran in a stable manner and thus had very good controllability. No blocking phenomena were observed during processing. The polymer material obtained shows properties comparable to the existing samples.

These preparatory experiments were the preparation for the step of transfer into the polymerization reactor.

The above-described reaction modules firstly permit the parallel operation of all 18 channels or parallel flow through a layer of 6 channels followed by deflection twice. First of all, a reactor module in which the flow passed through all 18 channels was used.

In the experimental procedure, the external thermostat for supply of the heating circuit ran at 78° C. The target reaction temperature was about 75° C. The temperatures measured by means of the three thermocouples introduced into the reaction channels were firstly close to this value (around 76° C.), and secondly also very close to one another (76.1° C., 76.4° C. and 76.0° C.), which underlines the good heat management of the reaction module. Two experiment runs were conducted at this temperature: one at initiator flow rate 0.30 ml/min and one at 0.60 ml/min. Particles were obtained in both cases. No blockage of the reaction module was observed during the experimental procedure.

The transfer of the process to the polymerization reactor was extended by the use of all three series-connected reaction modules. The existing process parameters were retained. This tripled the dwell time in the polymerization reactor to 3.3 minutes. Again, no blockage of the reactor was observed during the experimental procedure. The particle samples were dried in a vacuum drying cabinet.

A total of four sample series were run, which reflect the following different process conditions.
Continuous prepolymerization in capillary of length 20 m, 70° C.
Continuous prepolymerization in capillary of length 20 m, 85° C.
Continuous prepolymerization in polymerization reactor consisting of three modules, 70° C.
Continuous prepolymerization in polymerization reactor consisting of three modules, 85° C.

### LIST OF REFERENCE NUMERALS

1 polyacrylate particles
2 monomer
3 dispersant
4 surfactant
5 Pickering emulsifier.
6 dispersion
7 mixer
8 first reactor (capillary reactor)
9 capillaries
10 conduits
11 heat carrier medium
12 primary particles
13 second reactor
14 vessel
15 secondary particles
16 separation apparatus
17 recycle conduit

1. A process for producing polyacrylate particles by way of suspension polymerization and agglomeration, the process comprising:
a) providing a monomer solution comprising:
an acrylic acid that may have been at least partly neutralized;
at least one crosslinker;
at least one initiator or a portion of an initiator system; and
water;
b) providing an organic dispersant which is an aliphatic hydrocarbon or a mixture comprising an aliphatic hydrocarbon;
c) providing at least one surfactant;
d) providing at least one Pickering emulsifier;
e) producing a dispersion by dispersing the monomer solution in the dispersant;
f) polymerizing the acrylic acid within the dispersant in the presence of the at least one surfactant, which affords primary polyacrylate particles suspended in the dispersant;
g) agglomerating the primary polyacrylate particles within the dispersant and in the presence of the at least one Pickering emulsifier to obtain secondary polyacrylate particles;
h) separating the secondary polyacrylate particles from the dispersant;
wherein
i) the polymerizing is effected at least partly in a continuously operated first reactor having a multitude of capillaries aligned in parallel, wherein the interior of the capillaries forms a reaction space of the reactor and wherein the first reactor has at least one conduit that extends along the capillaries and through which a heat carrier medium flows;
k) and in that the agglomerating is effected at least partly in a discontinuously operated second reactor having at least one vessel, wherein the interior of the at least one vessel forms a reaction space of the second reactor.

2. The process according to claim 1, wherein both the surfactant and the at least one Pickering emulsifier are provided in the dispersant, in such a way that the producing of the dispersion and the polymerizing of the monomer are effected in the presence of the at least one surfactant and the at least one Pickering emulsifier.

3. The process according to claim 2, wherein the at least one surfactant and the at least one Pickering emulsifier are provided separately, namely in a first batch comprising the dispersant and the surfactant and in a second batch comprising the dispersant and the at least one Pickering emulsifier, and in that the dispersion is prepared by mixing the monomer with the first batch and then mixing the mixture of the first batch and monomer with the second batch.

4. The process according to claim 3, wherein the mixture of the first batch and monomer is mixed with the second batch is effected in at least one second microstructured mixer.

5. The process according to claim 3, wherein the monomer mixed with the first batch is effected in at least one first microstructured mixer, wherein the design of the at least one first microstructured mixture is selected from the group consisting of an interdigital mixer and a caterpillar mixer.

6. The process according to claim 1, wherein the at least one surfactant is provided in the dispersant, and in that the at least one Pickering emulsifier is metered in only on commencement of the agglomeration, in such a way that the preparation of the dispersion and the polymerization are effected in the presence of the at least one surfactant and in the absence of the at least one Pickering emulsifier.

7. The process according to claim 1, wherein a percentage change in mass of the polyacrylate particles on immersion into the dispersant, determined according to DIN EN ISO 175 (date of issue 2011 Mar. 1) at a test temperature of 70° C. and a test duration of 1 h is less than 100.

8. The process according to claim 1, wherein the surfactant is a sorbitan fatty acid ester.

9. The process according to claim 1, wherein the at least one Pickering emulsifier is an organoclay.

10. The process according to claim 1, wherein each capillary has a length L and an equivalent diameter d, wherein a L/d ratio of each capillary is between 50 and 500.

11. The process according to claim 10, wherein the equivalent diameter of the capillaries is between 1 mm and 10 mm.

12. The process according to claim 1, wherein the first reactor has a multitude of conduits that extend along the capillaries and through which the heat carrier medium flows, in such a way that the conduits for the heat carrier medium and the capillaries collectively form a parallel arrangement.

13. The process according to claim 1, wherein the monomer solution has the following components:
acrylic acid;
33% by weight to 50% by weight of sodium hydroxide, based on a weight of acrylic acid;
164% by weight to 247% by weight of water, based on the weight of acrylic acid;
778 ppm by weight to 1167 ppm by weight of N,N′-methylenebisacrylamide as the at least one crosslinker, based on the weight of acrylic acid;
1206 ppm by weight to 1809 ppm by weight of potassium peroxodisulfate as the at least one initiator, based on the weight of acrylic acid;
wherein cyclohexane is used as the dispersant,
wherein the amount of cyclohexane used is 606% by weight to 909% by weight, based on the weight of acrylic acid;
wherein a sorbitan fatty acid ester is used as the at least one surfactant,
wherein the amount of the sorbitan fatty acid ester used is 1% by weight to 2% by weight, based on the weight of acrylic acid;
and wherein a sheet silicate is used as the at least one Pickering emulsifier,
wherein the amount of sheet silicate used is 2% by weight to 3% by weight, based on the weight of acrylic acid.

14. The process according to claim 13, wherein the monomer solution is prepared as follows:
a) providing acrylic acid;
b) providing aqueous sodium hydroxide;
c) providing methylenebisacrylamide;
d) providing an aqueous solution comprising potassium peroxodisulfate;
e) mixing acrylic acid, aqueous sodium hydroxide and methylenebisacrylamide to obtain neutralized acrylic acid;
f) mixing the neutralized acrylic acid with the aqueous solution comprising potassium peroxodisulfate in at least one interdigital mixer.

15. The process according to claim 1, wherein the secondary polyacrylate particles separated from the dispersant are dried, wherein a D₅₀ value of the particle size distribution of the dried secondary polyacrylate particles determined according to ISO 17190-3 (2001-12-01 edition) is between 200 μm and 600 μm, with the proviso that neither the separated secondary particles nor the dried secondary polyacrylate particles are subjected to grinding and/or classification.

16. The process according to claim 4, wherein the mixture of the first batch and monomer mixed with the second batch is effected in a caterpillar mixer.
